(19) United States
(12) Patent Application Publication
(10) Pub. No.: US 2004/0146747 A1
(43) Pub. Date: Jul. 29, 2004

(54) Perpendicular magnetic recording medium

(75) Inventors: Hiroaki Nemoto, Oiso (JP); Ikuko Takekuma, Odawara (JP); Yuzuru Hosoe, Hino (JP); Hiroyuki Nakagawa, Yokohama (JP); Masukazu Igarashi, Kawagoe (JP)

Correspondence Address: REED SMITH LLP, 3110 FAIRVIEW PARK DRIVE, SUITE 1400, FALLS CHURCH, VA, 22042, US

(73) Assignee: Hitachi, Ltd.

(21) Appl. No.: 10/616,377

(22) Filed: Jul. 10, 2003

(30) Foreign Application Priority Data
Jan. 24, 2003 (JP) 2003-015526

(51) Int. Cl. B32B 3/00

(52) U.S. Cl. 428/694 T; 428/694 R

(57) ABSTRACT

Co/Pd or Co/Pt superlattice is provided to enable magnetic recording devices to sustain good recording/readback performances across a wide range of temperatures. Such a superlattice medium includes a substrate and a magnetic layer formed on the substrate and the magnetic layer comprises multilayer superlattice films of ferromagnetic metal layers which contain Co and paramagnetic metal layers which consist of Pd and/or Pt, wherein the ferromagnetic metal layers further contain a paramagnetic element and the thickness of the paramagnetic metal layers is 0.8 nm or less. When a magnetic torque loop of the perpendicular magnetic recording medium is measured with a torque magnetometer, the polarity of a value of loop components with translational symmetry of 90 degrees should be opposite to the polarity of a value of loop components with translational symmetry of 180 degrees. Perpendicular magnetic recording media of high performance are achieved in which high recording/readback signal quality is achieved and change in superlattice magnetic properties with extreme temperature change is suppressed.

### BACKGROUND OF THE INVENTION

(1) Field of the Invention

The present invention relates to a perpendicular magnetic recording medium and a method of fabricating thereof.

(2) Description of Related Art

In 1990s and later, the areal density of magnetic disk drives (HDDs) has been increasing sharply at an annual rate of 60-100 percent. During these years, for the purpose of noise reduction for magnetic recording media, study efforts have been made to decrease the diameter of crystalline grains in the media and weaken intergranular magnetic coupling. As magnetic grains are made smaller, the thermal energy required to flip their magnetization can be so low that the magnetization would be thermally unstable. In consequence, magnetic grains that make up a bit for recording cannot hold their orientations of magnetization immediately after recording, which results in decrease in readback output. This phenomenon is called thermal decay and this is not negligible for magnetic recording media with recording density of 50 Gb/inch² or higher.

To solve this problem, the study and development of perpendicular magnetic recording to supersede the existing longitudinal magnetic recording are underway. Perpendicular magnetic recording is believed to be better for high density recording than longitudinal magnetic recording because, for adjacent bits, the leakage field from one bit acts to stabilize the magnetization of the other bit. However, for perpendicular magnetic recoding films of CoCr alloys that have been studied heretofore, it has been found that avoiding the above thermal decay phenomenon is difficult when achieving high density recording. This problem is intrinsically due to that the perpendicular magnetic anisotropy energy (Kᵤ) of perpendicular magnetic recording media of CoCr alloys is not large enough to resist thermal fluctuation at environmental temperature.

In order to break through this difficulty, the development of perpendicular magnetic recording media with superlattice multilayers is underway. Superlattice multilayers are artificially fabricated by depositing thin films each with a thickness of atomic distance degree and can be made to have particular properties that are impossible for natural materials to have. Carcia et al. reported in Appl. Phys. Lett. 47 (1985) 178 that Co/Pd (Pt) superlattice multilayers fabricated by depositing Co and Pd or Pt atomic layers have large perpendicular magnetic anisotropy energy. In superlattice multilayers, it is supposed that perpendicular magnetic anisotropy rises at Co/Pd (Pt) interfaces and the superlattice multilayers exhibit a greater Kᵤ than the magnetic recording media of CoCr alloys. If such multilayers with magnetic properties showing a greater Kᵤ can be used as magnetic recording film structure, magnetic recording media that are strong to thermal fluctuation and with reduced thermal decay can be attained.

In order to use Co/Pd (Pt) superlattice multilayers as magnetic recording film structure, highly accurate recording with magnetic heads, that is, low noise recording must be achievable. To accomplish this, it is required that the magnetic layer comprising multilayer superlattice films is not uniform and has grain boundaries and a collection of microscopic magnetic grains separated by the grain boundaries constitutes a magnetic array. The magnetic gains surrounded by the grain boundaries are units of magnetization reversal. Based on the units of magnetization reversal, bits for recording (domains of magnetization reversal) are formed. Thus, the smaller the area of a magnetic grain, the bits for recording with higher accuracy and closer to the intended shapes can be formed, that is, low noise recording can be achieved.

When fine grains are formed in columns well separated with grain boundaries, they come to have large coercivity because the magnetization of the grains rotates coherently (Stoner-Wohlfarth type) during a magnetization reversal process. Superlattice multilayers having easy axes of magnetization in the perpendicular direction show a tendency that, in the vicinity of coercivity, a slope that corresponds to reversal of magnetization in an M-H loop; i.e., M-H slope parameter α becomes small. Here, a is also called a magnetization reversal parameter or the like and defined by the following formula (1).

$$α = \frac{Δ M}{Δ H} {\vert}_{H = {H}_{c}} [ MKAS system of units ] \qquad ( 1 )$$

For a complete columnar structure in which grains are segregated with boundaries, if intergranular exchange coupling is made negligibly small as compared with magnetostatic interaction, α is known to be approximately 1.

From the above-discussed background, diverse study efforts have been made to form the columnar structure in which grains are well segregated with boundaries in Co/Pd (Pt) superlattice multilayers and enable low noise recording. Referring to reference literature, study results reported so far will be noted below.

Japanese Laid-Open No. 2002-25032 disclosed a method for fabricating a superlattice medium by sputtering in which target Co and Pd films dosed with B as an additive element are deposited in an oxygen atmosphere, thereby obtaining properties suitable for magnetic recording media.

The material and the method of depositing a seed layer which is formed directly under a superlattice multilayer are known to be important factors in determining a columnar structure in which grains are segregated with boundaries. The microscopic texture of a superlattice multilayer which is deposited, following the formation of the granular seed layer satisfying certain requirements, is thought to be formed, generally tracing the texture of the seed layer, and come to have a columnar structure in which grains are segregated with boundaries.

In Japanese Laid-Open No. 2001-155329, such a method was reported that metal having a face-centered cubic structure such as Pt, Au, and Pd, dosed with an oxide is used as a seed layer. J. Appl. Phys., Vol. 91, No. 10, 8073 and material No. 4 on the 154th research council, the 144th committee of Nihon Gakujyutsu-Shinko-kai suggested that superlattice media having a better columnar structure in which grains are well segregated with boundaries can be obtained by using a 3-nm thick Pd layer dosed with a silicon nitride as the seed layer.

Methods in which oxide and metal layers are deposited sequentially to form seed layers have been tested. In J. Appl. Phys., Vol., 87, No.9, p.6358 and IEEE Trans. Magn., Vol. 37, No.4, p. 1577, it was reported that Co/Pd superlattice multilayers fabricated on indium tin oxide (ITO) seed layers have well segregated columnar structures. The magnetic properties (a magnetization hysteresis loop and other characteristics) of the reported magnetic films were compared with those obtained by computer simulation and it was verified that α decreases as the columnar structure of the grains is developed clearly in J. Appl. Phys., Vol. 87, No.9, p. 6361.

According to the above reports, it is anticipated that the grain boundaries consist of either sparse amorphous materials or simply voids.

The present inventors fabricated Co/Pd superlattice multilayers, referring to the above-mentioned methods incorporated herein as publicly known examples of prior art of the present subject. We obtained a magnetic layer showing magnetic properties with coercivity H_{c} of 400 [kA/m] and squareness of 1 (the remanent squareness of the magnetization hysteresis loop). The perpendicular hysteresis loop of the above superlattice indicated that the magnetization reversal parameter α was approximately 1 and the magnetization of the grains in the magnetic layer rotated coherently during reversal. The microscopic layer structure was observed by transmission electron microscopy (TEM). TEM images showed the formation of a columnar structure in which grains were segregated with boundaries on the entire surface of the magnetic layer, as is shown in FIG. 1, wherein the diameter of a magnetic grain surrounded by the grain boundaries was about 10 nanometers. In these sample superlattice multilayers, it is believed that magnetization reversal takes place in units of the magnetic grains. Using these superlattice multilayers, we fabricated a perpendicular magnetic recording medium and performed recording/readback tests of the medium at room temperature. The tested medium exhibited recording/readback performances equivalent to or better than conventional perpendicular magnetic recording media using CoCr-based alloys.

Moreover, we put the perpendicular magnetic recording medium comprising the above Co/Pd superlattice multilayers in a temperature-controled chamber at a temperature of 70 degrees Celsius and performed the recording/readback tests again. It was observed that the S/N ratio became worse much than that at room temperature and signal intensity decreased much due to thermal decay. Through detailed examination of the dependence of coercivity H_{c} of the above Co/Pd superlattice multilayers on temperature, we found great change in the coercivity H_{c} with temperature change. This phenomenon generally occurs on conventional perpendicular magnetic recording media using CoCr alloys, but was found to occur severely on the magnetic recording medium using the superlattice multilayers.

The problem that the recording/readback performances of the perpendicular magnetic recording medium using the Co/Pd superlattice multilayers greatly change with temperature change is attributed to change in the magnetic properties of the superlattice multilayers, depending on temperature.

Magnetic disks come into use in a variety of environments as their application spreads. As for their use in computer systems, which is the major application at the present, HDD manufacturers are required to assure proper HDD performance in environments at or higher than room temperature. Usually, there are diverse sources of heat generation including the HDD itself in a computer system and there is a possibility that the HDD operating temperature rises up to a temperature domain much higher than ambient temperature in the vicinity of room temperature. Though consideration of this possibility, the current HDDs are designed to satisfy specified performance across the operating temperature range of 25-70 degrees Celsius. For HDDs that are used in in-vehicle equipment for recording/readback, they must be supposed to operate in such an environment that they may be exposed to temperatures from −30 to 100 degrees Celsius. As for HDDs that are used as recording/readback devices for home electronics, they are supposed to be used in cooling equipment or an environment where high-density installation is required and it is desirable that they have a wide range of operating temperatures. When developers design a recording/readback device, temperature-dependent change in the recording/readback performances must be suppressed within specified design margins.

If temperature-dependent change in the magnetic properties of magnetic recording media is large, trouble is liable to occur in data stability in a high temperature domain due to thermal fluctuation. In a low temperature domain, with the rise in coercivity, a greater magnetic field for recording is required and this makes it difficult to design recording heads. Domain shapes of bits for recording change, depending on temperature. Such problems would give rise to serious difficulty in carrying out practical design of a recording/readback device.

Through examination, the inventors found that the phenomenon that the coercivity H_{c} of the sample medium greatly changed with extreme temperature change occurred only when the value of magnetization reversal parameter α of the superlattice sample fell within the range of 0.5-2.0, that is, the parameter α was in the vicinity of 1 and the magnetization of the grains rotated coherently during reversal. As noted above, because good squareness with the parameter α being in the vicinity of 1 is necessary for achieving low noise recording, it is difficult for the perpendicular magnetic recoding media using the previous superlattice multilayers to suppress the temperature-dependent change of H_{c} while reducing the media noise.

### SUMMARY OF THE INVENTION

The present invention has been proposed to resolve the above-described problems and provide a magnetic recording medium with properties better for use as high-performance perpendicular magnetic recording media in which high quality of recording/readback signals is achieved, while the temperature-dependent change of the magnetic properties of superlattice films is suppressed.

A perpendicular magnetic recording medium in accordance with the present invention is primarily characterized in that its magnetic layer comprises multilayer superlattice films of ferromagnetic metal layers containing Co and paramagnetic metal layers consisting of Pd and/or Pt, the ferromagnetic metal layers further contain a paramagnetic element, and the thickness of the paramagnetic metal layers is 0.8 nm or less.

The magnetic layer which comprises multilayer superlattice films of ferromagnetic metal layers containing Co and paramagnetic metal layers consisting of Pd and/or Pt is characterized in that the rate of decrease in coercivity of the magnetic layer, if exposed to extreme temperature change, shall be less than 0.15 when the rate is evaluated by formula: [H_{c} at 25 degrees Celsius−H_{c} at 70 degrees Celsius]/H_{c} at 25 degrees Celsius, where H_{c} is the coercivity of the magnetic layer.

The magnetic layer which comprises multilayer superlattice films of ferromagnetic metal layers containing Co and paramagnetic metal layers consisting of Pd and/or Pt is characterized in that, when a magnetic moment torque loop of the perpendicular magnetic recording medium is measured with a torque magnetometer, the polarity of a value of loop components with translational symmetry of 90 degrees is opposite to the polarity of a value of loop components with translational symmetry of 180 degrees.

The medium of the present invention constructed as described above is resistant to thermal fluctuation because of having a great value of Kᵤ, includes grain boundaries which are non-ferromagnetic in the superlattice films, wherein the superlattice films consist of magnetic grains segregated on the transverse level by the grain boundaries, exhibits a high signal-to-noise ratio, and the rate of change in coercivity H_{c} keeps low across a wide range of HDD environmental temperatures, for example, from 25 to 70 degrees Celsius.

### BRIEF DESCRIPTION OF THE DRAWINGS

FIG. 1 shows a columnar structure in which gains are segregated with boundaries formed in a recording magnetic layer comprising superlattice films.

FIG. 2 shows the schematic structure of a magnetic recording medium of Embodiment 1.

FIG. 3 shows a schematic of equipment with rotary triple cathodes used to fabricate the magnetic recording medium of Embodiment 1.

FIG. 4 shows the magnetization hysteresis loops of magnetic recording media samples produced by the method described in Embodiment 1.

FIG. 5 shows a relationship between Pd layer thickness and saturation magnetization in the magnetic recoding medium of Embodiment 1.

FIG. 6 shows a relationship between Pd layer thickness and perpendicular magnetic anisotropy energy per layer in the magnetic recoding medium of Embodiment 1.

FIG. 7 shows saturation magnetization distribution in a Pd layer, conjectured from the result of FIG. 5.

FIG. 8 shows a relationship between the magnetic moment induced in a Pd layer and perpendicular magnetic anisotropy energy.

FIG. 9 shows a relationship between Pd layer thickness and coercivity in the magnetic recoding medium of Embodiment 1 and temperature-dependent change of coercivity.

FIG. 10 shows the rate of decrease in coercivity and perpendicular magnetic anisotropy energy in the magnetic recording medium of Embodiment 1.

FIG. 11 shows a relationship between sputtering gas pressure during the deposition process of a superlattice medium of Embodiment 2 and the rate of decrease in coercivity.

FIG. 12 shows a relationship between Pd layer thickness and perpendicular magnetic anisotropy energy per layer when Ar gas pressure during the deposition process is 2 Pa and 5 Pa.

FIG. 13 shows a relationship between impurity materials doped into the Co/Pd superlattice and the doping manner in Embodiment 3 and the rate of decrease in coercivity.

FIG. 14 shows a relationship between dosage of B doped into the Co/Pd superlattice and perpendicular magnetic anisotropy energy.

FIG. 15A shows the magnetization hysteresis loops of magnetic recoding media samples produced by the method described in Embodiment 4.

FIG. 15B illustrates a method of obtaining a start point of magnetization reversal.

FIG. 16 shows a relationship between CoCu₂₀B₁₀ alloy layer thickness in the magnetic recording medium of Embodiment 4 and the reversal start point of magnetic field.

FIG. 17 shows a medium with crystalline orientations being dispersed and a medium with crystalline orientations not being dispersed for comparison in Embodiment 5.

FIG. 18 shows readback signal intensity change with time for perpendicular magnetic recording media samples of Table 1: Embodiment 1.

FIG. 19 shows recording resolution for perpendicular magnetic recording media samples of Table 1: Embodiment 1.

FIG. 20 shows a relationship between environment temperatures when recording on the media was performed and SNR for perpendicular magnetic recording media samples of Table 1: Embodiment 1.

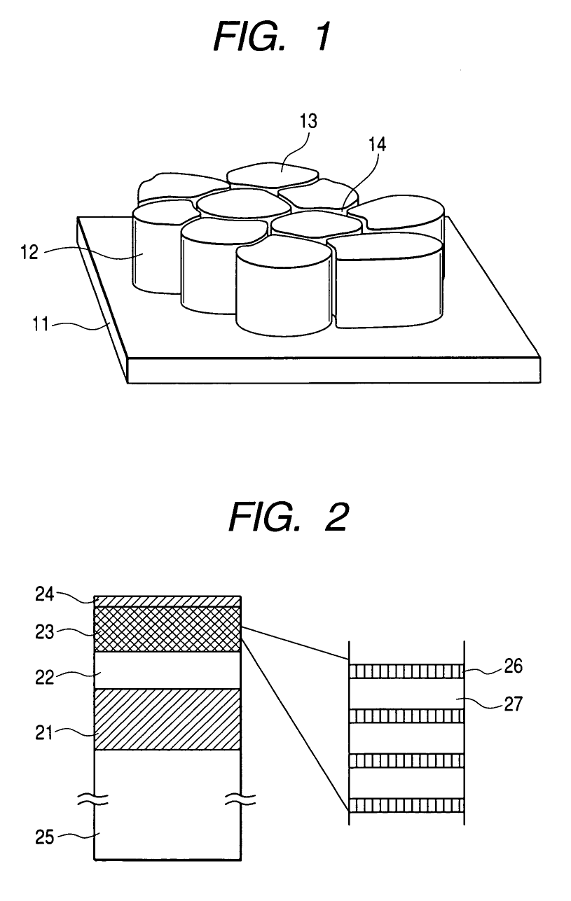

### DETAILED DESCRIPTION OF THE PREFERRED EMBODIMENTS

The present invention now is described fully hereinafter with reference to specific examples of its embodiments that are illustrated in the accompanying drawings.

A perpendicular magnetic recording medium to which the present invention applies includes a substrate and a magnetic layer formed on the substrate and the magnetic layer comprises multilayer superlattice films of ferromagnetic metal layers which contain Co and paramagnetic metal layers which consist of Pd and/or Pt. The ferromagnetic metal layers further contain a paramagnetic element and the thickness of the paramagnetic metal layers is 0.8 nm or less. The magnetic layer consists of magnetic grains which are relatively dense and magnetic gain boundaries which are relatively sparse, surrounding the magnetic gains.

Also, the perpendicular magnetic recording medium to which the present invention applies is characterized in that the rate of decrease in coercivity of the magnetic layer, if exposed to temperature change, shall be less than 0.15 when the rate is evaluated by formula: [H_{c} at 25 degrees Celsius−H_{c} at 70 degrees Celsius]/H_{c} at 25 degrees Celsius, where H_{c} is the coercivity of the magnetic layer. The M-H slope parameter a for the slope that corresponds to reversal of magnetization in an M-H loop should fall within the range of 0.5-2.0.

Furthermore, the perpendicular magnetic recording medium to which the present invention applies is characterized in that, when a magnetic torque loop of the perpendicular magnetic recording medium is measured with a torque magnetometer, the polarity of a value of loop components with translational symmetry of 90 degrees is opposite to the polarity of a value of loop components with translational symmetry of 180 degrees.

The magnetic properties of superlattice multilayers change with temperature change. The inventors investigated the reason why the coercivity H_{c} greatly changes with temperature change and found that, when the coercivity H_{c} greatly changes, perpendicular magnetic anisotropy energy Kᵤ also greatly changes with extreme temperature change. For the magnetic layer in which the value of magnetization reversal parameter a falls within the range of 0.5-2.0, the magnetization of the grains rotate almost coherently during reversal and, thus, H_{c} is in proportion to Kᵤ as known from the Stoner-Wohlfarth theory. The reason why H_{c} greatly changes with temperature change when the magnetization reversal parameter α is in the vicinity of 1 is due to that H_{c} is susceptible to change, responsive to the change of Kᵤ. Therefore, even for the magnetic layer in which a falls within the range of 0.5-2.0, the temperature-dependent change of H_{c} can be suppressed by suppressing the temperature-dependent change of Kᵤ.

Through detailed examination of the dependence of Kᵤ of the superlattice sample on temperature, it was found that the rate of change of Kᵤ with temperature strongly depends on the thickness of noble metal layers in the superlattice. When the noble metal layers were formed to have a thickness of 0.8 nm or less, the rate of change of Kᵤ with temperature decreased. Accordingly, the rate of change of H_{c} with temperature decreased and we obtained a superlattice medium with a smaller rate of change with temperature than previous magnetic recording media using superlattices. Narrowing the noble metal layer thickness in the superlattice is effective for suppressing the temperature-dependent change of H_{c}. Specifically, it is desirable to form all noble metal layers in the superlattice to have a thickness of 0.8 nm or less.

Moreover, when forming the superlattice films, the inventors found that the temperature-dependent change of Kᵤ can be suppressed by increasing the product of Ar gas pressure P_{Ar} in the sputter chamber and the distance D_{TS} between the substrate and the targets, P_{Ar}·D_{TS}. To suppress the temperature-dependent change of Kᵤ effectively, the value of P_{Ar}·D_{TS} should be 20 [Pa·cm] and above and, preferably, 50 [Pa·cm] and above. With the optimum setting of the value of P_{Ar}·D_{TS}, the rate of change of H_{c} with temperature decreased much.

The reason why the temperature-dependent change of Kᵤ was reduced through the above means, that is, by narrowing the noble metal layer thickness and increasing the value of P_{Ar}·D_{TS} has relation to the mechanism of generation of Kᵤ in the superlattice. Noble metal such as Pd and Pt does not have strong magnetization by itself. Under the influence of a ferromagnetic metal (for example, Co) adjacent to the noble metal layer in the superlattice, the magnetic moment is produced in the noble metal layer. According to the examination by the inventors, the greater the amount of the magnetic moment produced in the noble metal layer, Kᵤ in the superlattice increases more. To fabricate the superlattice having greater Kᵤ, as much magnetic moment as possible must be induced in noble metal layers, namely, Pd and Pt. If the noble metal layer is 1.0 nm thick or less, the noble metal layer should be made thicker to increase the total amount of the magnetic moment produced in the noble metal layer, thus increasing Kᵤ also.

However, the state of the magnetic moment in the noble metal atoms in positions away from the interface between the ferromagnetic metal layer and the noble metal layer is unstable and these noble metal atoms have peculiarity that magnetic properties are susceptible to change with environmental temperature change. According to the examination by the inventors, if the noble metal layer thickness is 0.8 nm and above, such unstable magnetic moment is produced. This causes Kᵤ to change greatly with temperature change. To keep the state of the magnetic moment in the noble metal layer stable and Kᵤ constant even when environmental temperature rises severely, the thickness of the noble metal layer should be set at 0.8 nm or less.

Increasing the product of gas pressure P_{Ar} in the chamber during a sputtering process and the distance D_{TS} between the substrate and the targets, P_{Ar}·D_{TS} also contributes to stabilizing the magnetic moment in the noble metal layer, thus suppressing the temperature-dependent change of Kᵤ. If the value of is P_{Ar}·D_{TS} is set great, sputter particles jetted from the targets collide with the gas repeatedly in the chamber and eventually settle on the substrate surface and, therefore, their kinetic energy is less. The inventors verified that the magnetic moment induced in noble metal atoms in the superlattice formed by such a soft film formation method was stable even in the positions away from the interface between the ferromagnetic metal layer and the noble metal layer because the noble metal atoms are exactly arranged in an intended crystalline structure.

In general, H_{c} is not always in proportion to Kᵤ. Thus, when the intergranular exchange coupling action is not reduced sufficiently with the value of a being 2.0 or above, the coercivity H_{c} is not influenced much by the change of Kᵤ and changes to a small degree with temperature change. In this case, however, the medium noise becomes great and this superlattice is unsuitable for perpendicular magnetic recording media. On the other hand, if the value of a is 0.5 or less, the easy axes of magnetization are believed to be not oriented uniformly in the perpendicular direction to the film plane and such a superlattice cannot be used as the perpendicular magnetic recording medium.

For the superlattice films fabricated to satisfy the above-described conditions, the average saturation magnetization Ms across all the Co/Pd (Pt) superlattice films tends to increase. As the noble metal layer thickness narrows, the Co component ratio in the superlattice rises and the average Ms increases. For the superlattice films fabricated with the setting of a greater value of P_{Ar}·D_{TS}, the magnetic moment induced in the noble metal layers is stabilized even if the superlattice structure is the same and the magnetic moment density increases. In other words, the saturation magnetization of the noble metal layers increases.

Excessively large saturation magnetization causes a sharp increase in the energy of demagnetizing fields applied to the magnetic layer and such a superlattice is unsuitable for the magnetic recording medium. To decrease the average saturation magnetization of the medium without affecting the magnetic moment stability in the Pd layers, it is desirable to actively dope metal additives into the Co layers and decrease the saturation magnetization in the Co layers. However, metal additives should not be doped into the noble metal layers and a noble metal layer should consist of Pd, Pt, or Pd/Pt alloy. This is because, if the noble metal layers are dosed with metal additives other than Pd or Pt, the atoms of the metal additives rapidly destabilize the magnetic moment induced in the noble metal layers. In that event, the H_{c} greatly changes with temperature change and the Kᵤ value rapidly decreases, and it is impossible to obtain properties required for perpendicular magnetic recording media.

Elements as the metal additives to be doped into the Co layers should have structure that does not disorder the Co/Pd (Pt) superlattice crystalline structure; that is, their atoms are arranged in a face-centered cubic lattice or hexagonal close packed lattice. Moreover, the elements should be capable of reducing the magnetization of the Co alloy to the order of 500-1000 kA/m. As the elements that have the above characteristics, the following can be mentioned: Pt, Pd, Au, Ag, Rh, Ru, and Cu. It is known that light elements such as B and C, if doped in a dosage of 20 atomic percent or less into the Co layers, have little effect on the Co alloy layers and facilitate the formation of a columnar structure in which grains are segregated with boundaries in an oxygen atmosphere (Japanese Laid-Open No. 2002-25032). Thus, such a light element may be added to the Co layers in addition to any of the above metal additives.

When a Co, Pd, or Pt film is deposited through a normal sputtering deposition process, the film has crystalline orientations such that dense crystalline planes are put in parallel with the film plane. In other words, the c axis of the hexagonal close packed lattice in the case of Co and the (111) axis of the face-centered cubic lattice in the case of Pd or Pt are put perpendicular to the film plane. Thus, the crystalline structure of the Co/Pd (Pt) superlattice films follows the crystalline orientations of these thin films and the crystalline axis corresponds to the c axis in the case of the Co layer or the (111) axis in the case of Pd (Pt) is put perpendicular to the film plane. This can be viewed through crystalline structure analysis by X-ray diffraction.

In the Co/Pd (Pt) superlattice multilayers in which a columnar structure in which grains are segregated with boundaries has been produced, fabricated by the above-noted methods as the publicly known examples of prior art, however, the crystalline orientations are lost and the magnetic grains surrounded by the boundaries have randomly oriented crystalline structures. The inventors found that much disordered crystalline orientations in these superlattice multilayers having a columnar structure in which grains are segregated with boundaries would result in great change in coercivity H_{c} with temperature change. This disordered crystalline orientation is regarded as one cause of the phenomenon that H_{c} greatly changes with temperature change, occurred in the superlattice magnetic films (having the above columnar structure of grains) in which the value of magnetization reversal parameter a falls within the range of 0.5-2.0.

To arrange the crystalline orientations of the Co/Pd (Pt) superlattice with the columnar structure in which grains are segregated with boundaries, it is advisable to form a seed layer in which atoms are easy to orientate toward a given direction and form the superlattice in accordance with the orientations of the seed layer. When the crystalline plane in which atoms are oriented toward a given direction is exposed on the surface of the seed layer, the superlattice with the columnar structure of grains, formed on it, tends to grow in the same orientation. Because the (111) axis of the face-centered cubic lattice of Pd or Pt is easy to put perpendicular to the film plane in the Co/Pd (Pt) superlattice, a material having the hexagonal close packed lattice or face-centered cubit lattice and a lattice constant not much different from that of Pd or Pt which is the material of the superlattice is suitable for the seed layer material. It was also found that, with larger lattice spacing, a greater H_{c} is easier to obtain. Seed layer materials that fulfill the purposes of arranging superlattice orientations are Pd, Pt, Au, Ag, and Ru, or alloys thereof. However, when Pd, Pt and a Pd/Pt alloy were used singly as the seed material, because of its excessively high affinity with the superlattice material, the columnar structure in which the grains are segregated with boundaries was hard to form and it was impossible to set α at 2.0 or less.

The seed layer made of any of the above-mentioned material, formed on the Pd layer, Pt layer, or Pd/Pt alloy layer that easily put the (111) axis in perpendicular orientation is more effective. Such seed layer combined with an oxide layer disclosed in the reference literature is still more effective.

Discrimination between a superlattice medium with crystalline orientations arranged by the above method and a superlattice medium without arranged crystalline orientations can be made, using a toque magnetometer. The inventors analyzed data obtained by Fourier transformation of a magnetic torque loop obtained from the measurements with the torque magnetometer. From the analysis, it was found that the values of torque loop components with translational symmetry of 90 degrees have the same polarity as that with translational symmetry of 180 degrees in the case of a superlattice with the columnar structure in which grains are segregated with boundaries and without arranged crystalline orientations and the opposite polarity in the case of a superlattice medium in which the orientations of the magnetic grains have been arranged by the above method. This data can be used as index of whether the temperature-dependent change of coercivity can be suppressed.

[Embodiment 1]

Embodiment 1 is a magnetic recording medium example comprising Co/Pd multilayer superlattice films in which Co alloy layers and Pd layers are stacked alternately. The stability of the magnetic moment in the Pd layers that acts to generate perpendicular magnetic anisotropy energy is strongly influenced by the gas pressure in the chamber during a sputter deposition process and the Pd layer thickness. This respect is discussed in this embodiment and one of the means for reducing the temperature-dependent change of coercivity H_{c}.

First, the schematic structure of the magnetic recording medium of Embodiment 1 is shown in FIG. 2. This magnetic recording medium was prepared to examine the magnetic properties of the superlattice and a soft magnetic underlayer that is necessary for perpendicular magnetic recording does not exist in it. The glass plane was covered with an Ni—Ta alloy to enhance adhesiveness and, on the Ni—Ta alloy layer, a Pd₈₀Ag₂₀ alloy seed layer (15 nm thick), a Co/Pd superlattice recording layer, and, finally, carbon protective layer (5 nm) were deposited in sequence. Deposition was performed by DC magnetron sputtering. To produce repetitive superlattice multilayers, it is necessary to deposit dozens of layers of Co alloy material and noble metal material alternately on the substrate.

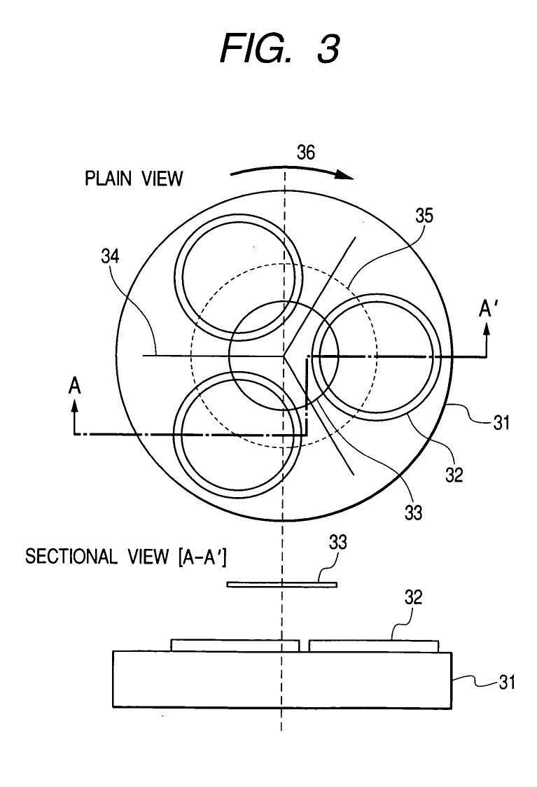

FIG. 3 shows a schematic of equipment with rotary triple cathodes (hereinafter referred to as rotary cathodes) used when fabricating the superlattice in Embodiment 1. This rotary cathodes system comprises three dependent sputtering cathodes placed on a rotary table. After the Co target and the Pd target are installed on the rotary cathodes, the rotary cathodes are rotated at 100 rpm and the targets are discharged at the same time. The substrate is placed, for example, on the center axis of the rotary table and the Co and Pd sputter particles are deposited in position on the substrate alternately.

By using this method, a high-speed deposition process can be performed to a degree that mass production of superlattice films is possible. By adjusting the electric power of sputtering the Co and Pd targets, the superlattice multilayers with predetermined thicknesses were produced. The deposition steps were time controlled so that a total superlattice thickness of 20 nm would be obtained by multiplying the thickness of each layer by the number of repetitive steps.

To examine the properties of the superlattice, we produced samples with varying multilayer structures. The thickness of the Co alloy layers was fixed to 0.3 nm and the thickness of the Pd layers was varied from 0 nm (a missing Pd layer) to 1.6 nm. The Ar gas pressure was set at 5 Pa during the Co/Pd superlattice deposition process. The distance between the substrate and the targets in the used sputter chamber was 5 cm.

For the purposes of producing the columnar structure in which grains are segregated with boundaries in the superlattice and decreasing the magnetization reversal parameter α, traces of oxygen gas were used in addition to the argon gas during the superlattice deposition process. The oxygen gas partial pressure was set at 20-60 mPa. FIG. 4 shows the magnetization hysteresis loops of superlattice samples produced with different settings of oxygen partial pressure P₀₂. When oxygen partial pressure P₀₂ is 40 mPa and over during the deposition process, a was 2 or less. In Embodiment 1, hereinafter, examination was made, assuming an oxygen partial pressure P₀₂ of 50 mPa for during the deposition process. Through the TEM images of the superlattice samples produced with the oxygen partial pressure of 50 mPa, the formation of a complete columnar structure in which grains were segregated with network-like boundaries which were sparse material was observed. The magnetic grains surrounded by the boundaries are considered as being isolated magnetically.

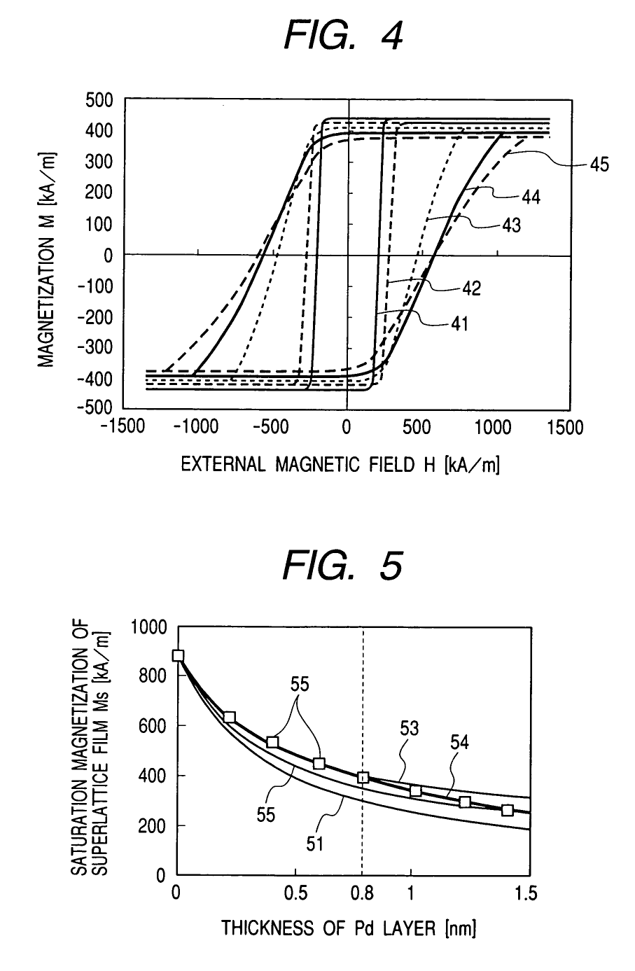

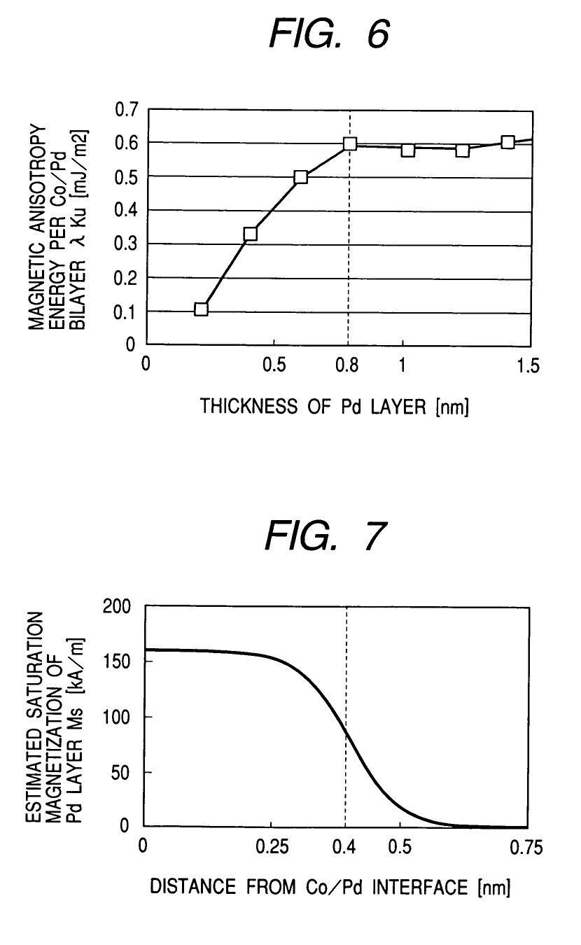

FIG. 5 shows a relationship between Pd layer thickness and saturation magnetization Mₛ in the superlattice. FIG. 6 shows a relationship between Pd layer thickness and perpendicular magnetic anisotropy energy per layer λKᵤ (where λ is a repetitive Co/Pd bi-layer thickness in superlattice). When magnetization in a Co layer is supposed to be 880 emu/cm³ (the measured value of magnetization when the Pd layer thickness is 0 nm), if suitable magnetization distribution in a Pd layer is assumed, change in the saturation magnetization of the Co/Pd superlattice, depending on the Pd layer thickness (FIG. 5) can be explained. This distribution is shown in FIG. 7. As discussed in J. Magn. Magn. Mater., 99, p. 71-80, it is believed that Pd magnetization tends to be magnetized at the interface with an Co alloy layer and the magnetization value decreases as distance from the interface increases. The graph shown in FIG. 7 experimentally proves the Pd magnetization properties described in the above reference literature. In FIG. 7, magnetization in a Pd layer became almost half at a point at a distance of 0.4 nm from the Co/Pd interface and rapidly decreased as the distance further increased. On the other hand, in FIG. 6, the Pd layer thickness when the anisotropy energy λKᵤ is saturated is about 0. 8 nm which is double the above critical distance.

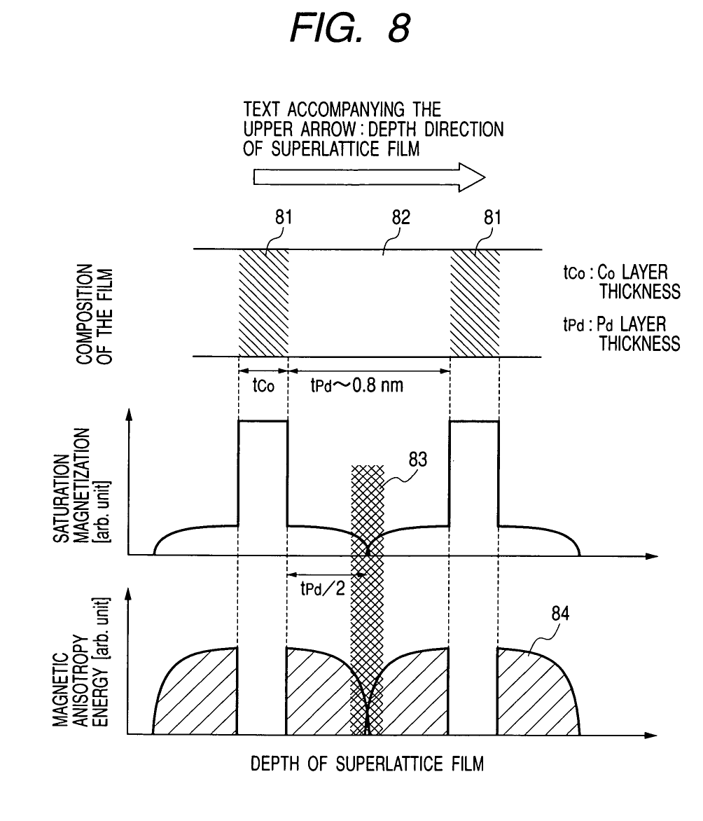

This result indicates that the perpendicular magnetic anisotropy of the superlattice rises in the magnetic moment induced in Pd. When the Pd layer thickness is less than 0.8 nm, the anisotropy energy λKᵤ, of the Co/Pd superlattice increases in proportional as the Pd layer thickness increases. When the Pd layer thickness becomes 0.8 nm and over, the magnetic moment no longer increases in the Pd layer and the increase in the anisotropy energy λKᵤ stops. FIG. 8 is a schematic diagram showing a relationship between the distribution of saturation magnetization in a Pd layer and the distribution of perpendicular magnetic anisotropy energy.

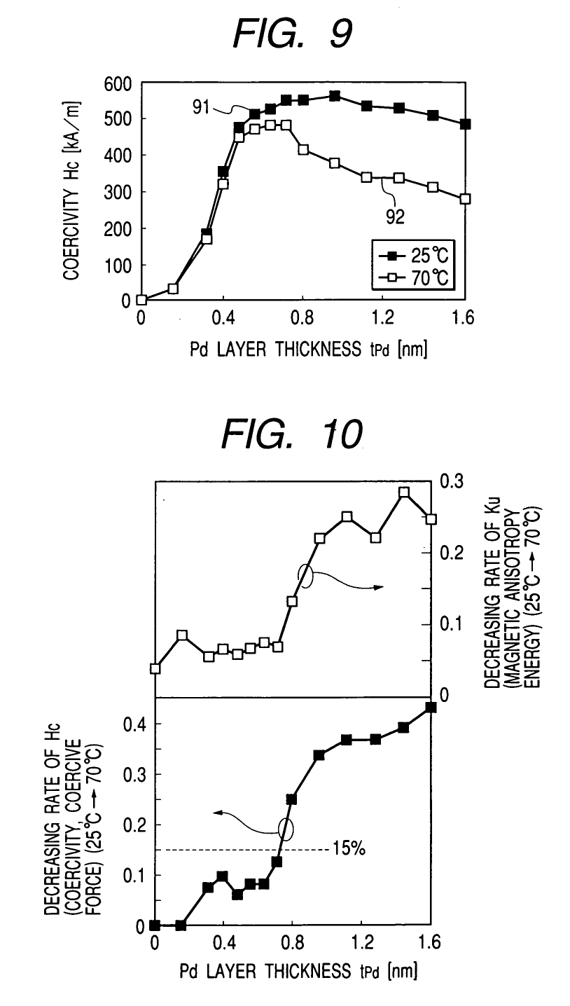

The magnetic moment in a zone away from the Co/Pd interface is unstable and liable to disappear with a rise of temperature. By making the Pd layer 0.8 nm thick and below and eliminating the unstable magnetization zone shown in FIG. 8, decrease in coercivity can be stopped. FIG. 9 shows comparison between coercivity at 25 degrees Celsius and coercivity at 70 degrees Celsius for different Pd layer thicknesses. FIG. 10 shows comparison between the rate of decrease in coercivity H_{c} obtained from FIG. 9 and the rate of decrease in Kᵤ measured separately when the superlattice is exposed to temperature change from 25 degrees Celsius to 70 degrees Celsius. The H_{c} change with temperature change well agrees with the change in the rate of Kᵤ change under the same temperature conditions and the decrease in Kᵤ directly leads to the H_{c} decrease phenomenon. Apparently, the rate of decrease in H_{c} steeply declined for Pd thickness of 0.8 nm and below.

As can be seen from FIG. 10, there are two domains with regard to the rate of decrease in coercivity H_{c} (with temp. change from 25 to 70 degrees Celsius): the rate is below 15% in one domain and above 15% in the other domain. A critical point between the two domains is a Pd layer thickness of 0.8 nm. If the rate of decrease in coercivity H_{c} is less than 15%, the unstable magnetization zone in a Pd layer indicated in FIG. 8 may be considered to have been disappeared. The superlattice of the present invention in which the rate of decrease in coercivity H_{c} is suppressed less than 15% with regard to H_{c} measured at 25 degrees Celsius and 70 degrees Celsius fulfills constraint (2) below:

$$\frac{{H}_{c} ( 25 ° C . ) - {H}_{c} ( 70 ° C . )}{{H}_{c} ( 25 ° C . )} < 0.15 \qquad ( 2 )$$

Because the rate of decrease in coercivity H_{c} is almost constant in the range of 25-70 degrees Celsius, it is reasonable to explain the rate of change in H_{c} with temperature change, using constraint (2) and the representative temperature values.

Of course, decrease in H_{c} with temperature rise occurs not only in the superlattice, also H_{c} of magnetic recording media generally decreases as temperature steeply rises. Similar measurements made for longitudinal magnetic recording media with CoCr-based alloys which are used in current magnetic disk drives showed that H_{c} decreased from 300 to 245 kA/m with temperature rise from 25 to 70 degrees Celsius. This rate of decrease in H_{c} is about 18% as calculated with formula (3) below:

$$\frac{{H}_{c} ( 25 ° C . ) - {H}_{c} ( 70 ° C . )}{{H}_{c} ( 25 ° C . )} = 0.183 \qquad ( 3 )$$

As can be seen from FIG. 10, the rate of decrease in coercivity H_{c} of previous Co/Pd superlattices with temperature rise is considerably large as compared with the value calculated with formula (3). However, optimum thickness settings of the Pd layers in the superlattices make it possible to fulfill constraint (2) and alleviate the problem of temperature-dependent change of H_{c}, thereby making superlattice media performance comparable to or better than conventional longitudinal magnetic recording media.

To verify the effect of suppression of the temperature-dependent change of coercivity, we fabricated a perpendicular magnetic recording medium in which the superlattice recording layer was combined with a soft magnetic underlayer formed on the substrate and evaluated recording/readback performances of the medium. Summary of two samples we evaluated is shown in Table 1. Sample B is the perpendicular magnetic recording medium of Embodiment 1 and sample A is a comparative example. The above-mentioned Pd₈₀Ag₂₀ alloy seed layer was formed and, on the top of it, the multilayer superlattice films, a total of about 20 nm thick, were formed. The thickness of a Pd layer in the superlattice was set at 1.0 nm and 0.7 nm in samples A and B, respectively. For both samples, a FeTa₃₇C₈ soft magnetic underlayer, 200 nm thick, was formed between the seed layer and the substrate and a carbon protective layer, 5 nm thick, was formed on the top of the recording layer. The coercivity measurements of the samples at 25 degrees Celsius were in the vicinity of 550 kA/m. However, the coercivity measurements of the samples at 70 degrees Celsius differed much: 365 kA/m for sample A, 34% decrease in coercivity; 485 kA/m for sample B, 9% decrease in coercivity. The thinner Pd layer thickness of sample B resulted in the reduced rate of decrease in coercivity with temperature change.

We mounted these samples on a recording/readback tester installed in a temperature-controlled chamber, fixed the head linear velocity at 8 m/s, and evaluated recording/readback performances of the samples. Recording on a track of the media was performed with a fixed density of magnetic reversal (flux change), using magnetic single-pole type (SPT) heads. Then, readback from the same track was performed, using GMR heads. Signal intensity was obtained from the amplitude of a readback signal and noise intensity was obtained by integrating disk noise components up to 100 MHz.

FIG. 18 shows the results of magnetic data recording and readback tests performed at 25 degrees Celsius and later readback tests performed at 70 degrees Celsius. Linear recording density was set at 400 kFCI (flux change per inch). As shown in FIG. 15, the measurements of signal-to-noise ratio (SNR) of both samples were almost the same immediately after recording. However, the SNR measurement of sample A considerably decreased with temperature rise to 70 degrees Celsius and continued to decrease as time elapsed. The SNR of sample B somewhat decreased with temperature rise to 70 degrees Celsius, but almost no decline in SNR was found. Seemingly, these results indicate the following. For sample A, its coercivity decreased considerably with temperature rise to 70 degrees Celsius, with the result that the readback signal amplitude was decreased by thermal decay. For sample B in which decrease in coercivity was suppressed, the medium was able to prevent thermal decay.

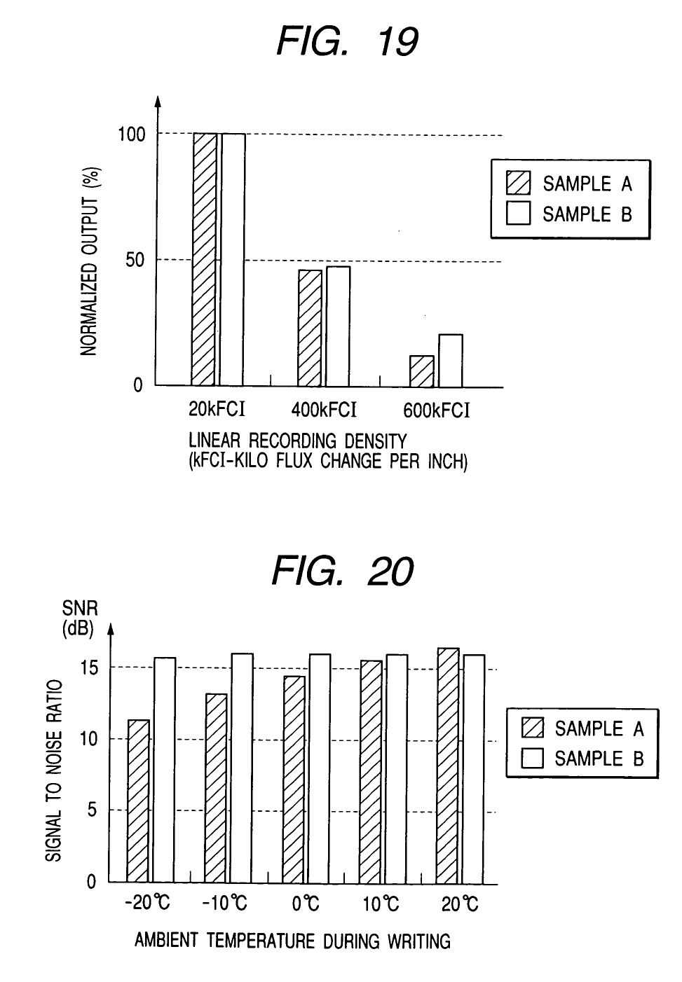

FIG. 19 shows the results of readback performance evaluation performed at 25 degrees Celsius after recording in environment with temperature of 70 degrees Celsius. For data recorded at different linear recording density of 20, 400, and 600 kFCI, the difference between their readback signal intensities was examined. The value of readback signal intensity obtained from data recorded at 20 kFCI was used for a reference as a normalized value. According to FIG. 19, the readback signal intensity of sample A decreased much for higher liner recording density, particularly, 600 kFCI. This indicates that sample A is inferior to sample B in recording resolution if recording is performed at high environment temperature. Conceivably, because of a considerable decrease in coercivity of sample A with temperature rise to 70 degrees Celsius, the width of magnetic transition increased and high density recording performance degraded.

FIG. 20 shows the results of readback performance evaluation performed at 25 degrees Celsius after recording in environments at −20, 10, 0, 10, and 20 degrees Celsius. For sample A, the SNR measurement decreased much as the recording environmental temperature decreased. For sample B, the SNR measurement somewhat decreased, but its degree of decrease was much smaller than sample A. Because coercivity of sample A greatly changes with temperature change, coercivity rises steeply at low temperatures. For sample A, thus, shortage of magnetic fields for recording occurs at low temperatures and, conceivably, this caused a decline in SNR, though it exhibited good recording performance around room temperature.

These evaluations showed that sample B, the perpendicular magnetic recording medium using the superlattice of Embodiment 1, exhibited recording/readback performances across a wide range of environmental temperatures, almost as good as those evaluated at 25 degrees Celsius, whereas, sample A, the comparative example, showed large degradation of recording/readback performances with environmental temperature change. By suppressing the temperature-dependent change of H_{c} in the way explained hereinbefore, change in the performance of magnetic disk drives with temperature change can be prevented. Also, the superlattice medium of the invention would make it easy to attain the goal of high density recording by perpendicular magnetic recording.

[Embodiment 2]

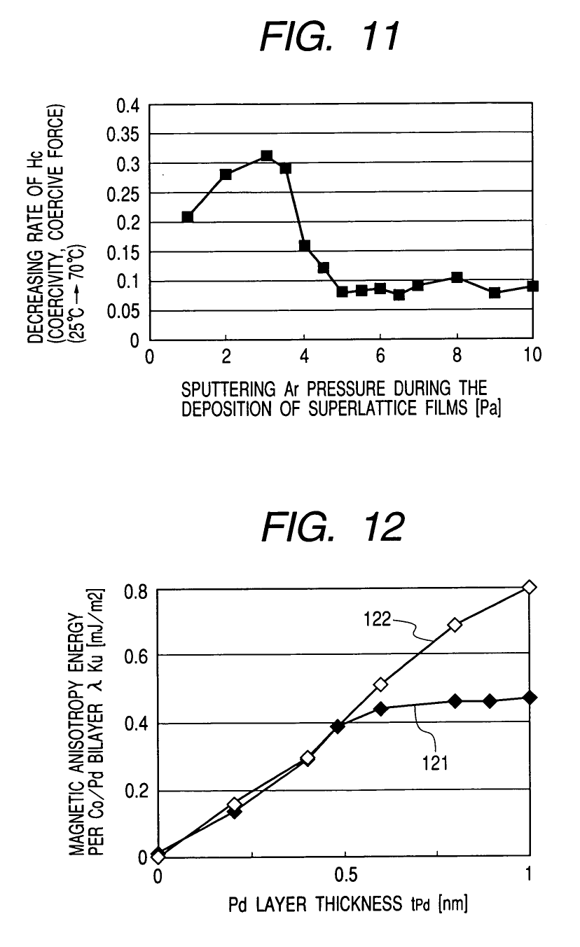

In Embodiment 2, the temperature-dependent change of H_{c} is suppressed in another way of fabricating the superlattice medium, based on the same principle as for Embodiment 1, and the result thereof is described. The same sputtering equipment as in Embodiment 1 was used. The fabricated superlattice medium is 20 nm thick (about 20 multilayers) in which the thickness of a Co alloy layer is 0.3 nm and the thickness of a Pd layer is 0.8 nm. Oxygen partial pressure in the sputter chamber was set at 50 mPa, the same as in Embodiment 1, and an Ru (20 nm) seed layer was employed. In order to examine the magnetic properties of the superlattice, the fabricated medium does not include a soft magnetic underlayer. In the thus fabricated superlattice medium, the magnetization reversal parameter a is 0.8 and the columnar structure in which grains are segregated with boundaries is formed, and, thereby, almost no intergranular exchange coupling takes place. FIG. 11 shows a relationship between Ar gas pressure during a deposition process and temperature-dependent change of coercivity H_{c}. In FIG. 11, the shaded area is the area where the columnar structure of grains is not formed well and excluded out of consideration because the magnetization reversal mechanism in the area is different.

According to FIG. 11, the rate of change in H_{c} with temperature change increases when Ar gas pressure is 4 Pa and below, though the Pd layer thickness is 0.8 nm. FIG. 12 shows comparison between perpendicular magnetic anisotropy energy λKᵤ per layer when Ar gas pressure in the sputter chamber during the Co/Pd superlattice sputter deposition process is 2 Pa and the λKᵤ when the Ar gas pressure is 5 Pa (FIG. 4). In a domain that the Pd layer is thinner, the anisotropy energy λKᵤ tends to increase almost in proportion as the Pd thickness increases for both cases. In the case of deposition with the Ar gas pressure of 2 Pa, the increase of anisotropy energy λKᵤ stops when the Pd layer becomes 0.5-0.6 nm. In the case of deposition with the Ar gas pressure of 5 Pa, the increase of anisotropy energy λKᵤ continues as the Pd layer thickness increases up to 1.0 nm.

As discussed in Embodiment 1, the behavior of λKᵤ indicate the Pd layer thickness range in which the stability of magnetic moment in the Pd layer is maintained. The properties of the superlattice formed through deposition with the Ar gas pressure of 2 Pa differ from those of the superlattice formed through deposition with the Ar gas pressure of 5 Pa. For the superlattice formed through deposition with the Ar gas pressure of 2 Pa, the magnetic moment in the Pd layer becomes unstable when the Pd layer thickness exceeds 0.5 nm. For the superlattice formed through deposition with the Ar gas pressure of 5 Pa, the magnetic moment keeps stable as the Pd thickness increases up to 1.0 nm. Thus, the characteristic of temperature-dependent change of H_{c} of the former superlattice significantly differs from that of the latter superlattice. Referring to FIG. 11, the rate of decrease in coercivity with regard to sputtering gas pressure also tend to be distinctively separated into two domains: the rate of decrease in coercivity with temperature change is smaller in one domain (4 Pa and higher pressure in FIG. 11) and the rate is larger in the other domain (pressure lower than 4 Pa in FIG. 11). A critical point between the two domains is 4 Pa. A critical point between the higher rate of decrease in H_{c} with temperature change (from 25 to 70 degrees Celsius) and the lower rate thereof is about 15% also in this case. These results indicate that the superlattice in which the magnetic moment in the Pd layer keeps stable, as described above, fulfills constraint (2) also.

As regards the reason why the magnetic moment in the Pd layer is stabilized by increasing the sputtering gas pressure, the inventors have the following thoughts. As the Ar gas pressure increases, the sputter particles collide with Ar atoms in the chamber more readily and the average kinetic energy of the sputter particles decreases. With higher Ar gas pressure, lower energy sputter particles are deposited on the superlattice and the microscopic superlattice structure become harder to break, and, therefore, the magnetic moment in the Pd layer becomes stable. Actually, however, we do not understand how different are the microscopic superlattice structure formed with high gas pressure and such structure formed with low gas pressure.

As described above, forming superlattices by sputtering under high gas pressure is effective for suppressing the temperature-dependent change of coercivity H_{c}. However, it must be considered that Ar gas pressure required during the sputtering deposition process depends on the chamber form that is used. While the distance between the substrate and the targets is 5 cm in this embodiment, if the distance doubles, even if the Ar gas pressure is reduced by half, the probability of collision between the sputter particles and Ar atoms remains the same. Rare gas atoms such as Xe and Kr may be used instead of Ar atoms. In that event, conditions will change, since these atoms have a greater atomic weight than Ar atoms and can draw energy from sputter particles efficiently.

[Embodiment 3]

In Embodiment 3, different superlattices are fabricated in such a manner that metal impurities are doped into Co and Pd alloy layers, and the result of comparison and examination thereof is described.

In Embodiment 3, a common basic superlattice structure consists of 0.3 nm thick Co alloy layers and 0.8 nm thick Pd alloy layers and these multilayer superlattice films are a total of 20 nm thick. The superlattice films are deposited in the same method as in Embodiments 1 and 2. As is the case for Embodiment 2, the Ru (20 nm) seed layer is used. In order to examine the magnetic properties of the superlattice, the fabricated medium does not include a soft magnetic underlayer. Three metal additives, Cu, Ag, and Pt were singly doped into Co alloy targets only, Pd alloy targets only, and both Co and Pd targets, and the three respective cases were examined. A dosage of impurities doped into a target was 10 atomic percent.

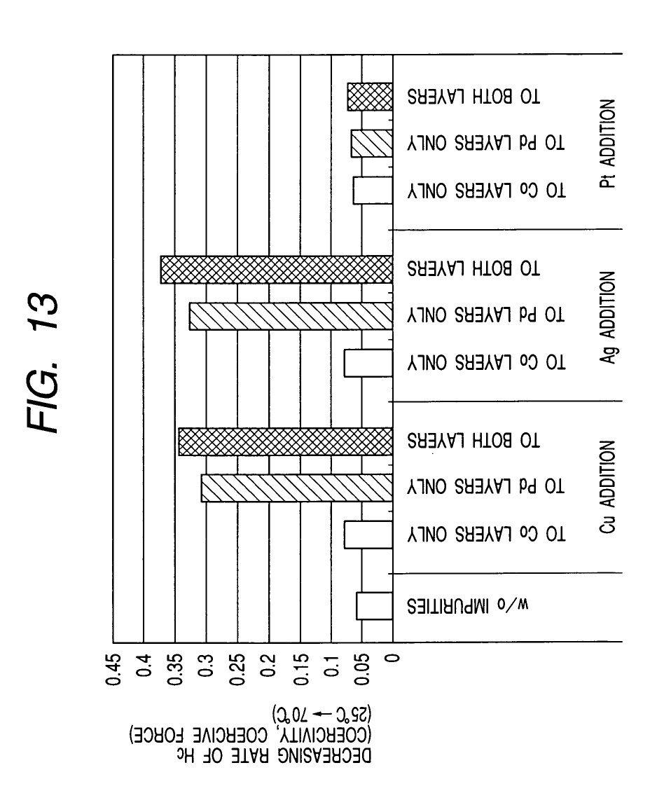

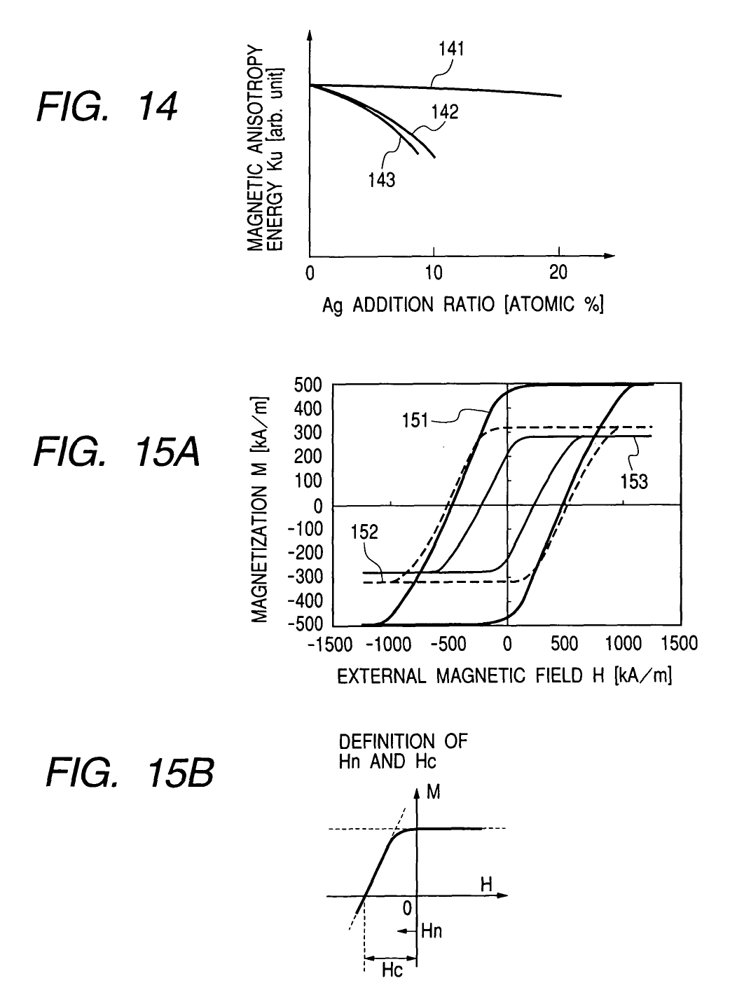

FIG. 13 shows the rates of decrease in H_{c} of the thus produced superlattices. As for additives Cu and Ag, doping each additive into Co layers only does not cause much change in the rate of decrease in H_{c}, as compared with the non-doped superlattice, but doping each additive into Pd layers cause a great increase in the rate of decrease. This would be because the state of the magnetic moment in a Pd layer that acts to generate perpendicular magnetic anisotropy energy Kᵤ is destabilized mainly by impurities in the Pd layer. FIG. 14 shows the relationship between Ag element dosage and what layer dosed with Ag versus Kᵤ. When only Co layers were dosed with Ag, much change did not occur; whereas, when Pd layers were dosed with Ag, Kᵤ decreased much. This result confirm the above conjecture.

However, Pt impurities are exceptional; doping Pt additives into Pd layers does not cause increase in the rate of decrease in H_{c}, though Cu and Ag do so. Therefore, doping Pt elements into Pd layers almost does not produce an adverse effect of destabilizing the state of the magnetic moment. This is also true for cases where Pd elements are doped into Co/Pt superlattice multilayers.

Doping impurities into Pd layers has a great adverse effect on the stability of the medium to heat as explained above, but it is possible to dope impurities into Co layers. As disclosed in Japanese Laid-Open No. 2002-25032, doping makes it easy to form a columnar structure in which grains are segregated with boundaries and enhances the magnetic recording medium performance. Thus, it is desirable to dope impurities into only Co layers as means for suppressing the temperature-dependent change of H_{c}, while decreasing α. Layers dosed with oxide such as SiO₂ as impurities did not show significant difference, whether they were Pd or Co. This is attributable to the fact that additives other than metal elements do not have much effect on the state of electrons in Pd layers.

[Embodiment 4]

As described in Embodiment 1, to make noble metal layers thinner is effective for suppressing decrease in H_{c} with temperature rise. However, as the noble metal layers thin, the volume proportion of ferromagnetic metal layers increases relatively and the average saturation magnetization of the superlattice increases. In consequence, the influence of demagnetizing fields strengthen, which results in a decline in thermal stability. Thus, it is advisable to actively dope impurities into Co layers and reduce the saturation magnetization in the Co alloy layers, as noted in Embodiment 3. In Embodiment 4, Co/Pd superlattice samples in which 10 atomic percent Ag was doped into Co layers, samples in which 10 atomic percent Cr was doped into Co layers, and non-doped samples are compared and consideration is made as to a relationship between each material doped into the Co alloy layers of Co/Pd superlattice and the magnetic properties.

The same sputtering equipment as in Embodiment 1 was used to produce the samples. However, the deposition process using oxygen gas additionally as in Embodiment 1 was not adopted. On one of the cathodes placed on the rotary table, shown in FIG. 3, an SiO₂ target was installed, and this target, Co alloy target, and Pd target were discharged at the same time and a superlattice deposition process was performed. In this case, SiO₂ cohesion occurred, separated from ferromagnetic metal elements and noble metal elements and formed a columnar structure in which grains are segregated with boundaries in the superlattice. Consequently, a superlattice medium with a on the order of 1 and below was obtained without using the method of deposition in oxygen gas which was adopted in Embodiment 1. In the Co alloy/Pd superlattice samples, the Pd layer thickness was fixed to 0.6 nm and the Co alloy layer thickness was varied in a range of 0.2-0.8 nm. Repetitive layer formation steps were controlled to form multilayer superlattice films with a total thickness of about 20 nm. The Pd₈₀Ag₂₀ alloy seed layer (20 nm) was employed. Since these samples are used to examine the magnetic properties of the superlattice, a soft magnetic underlayer was not formed.

FIG. 15A shows comparison of the magnetization hysteresis loops of the Ag-doped, Cr-doped, and non-doped samples wherein the Co (alloy) layers are 0.3 nm thick and the Pd layers are 0.6 nm. FIG. 15B shows a method of obtaining a magnetization reversal start point of magnetic field Hₙ from these hysteresis loops. Hₙ is a parameter that indicates the stability of magnetization state. In general, if the Hₙ value is negative, magnetization is stable with no magnetic field. If the Hₙ value is positive, after magnetization is saturated once, it decreases while being allowed to stand. From FIG. 15A, for non-doped superlattice, because of a great saturation magnetization of 500 kA/m, Hₙ was −35 kA/m, which was negative marginally. For superlattices in which Ar or Cr was doped into the Co layers, saturation magnetization decreased to 310 kA/m and 280 kA/m, respectively. As a result, for Ag-doped superlattice, H_{c} was −200 kA/m. However, for Cr-doped superlattice, the decrease in saturation magnetization was accompanied by decrease in H_{c} and, consequently, Hₙ became positive, +20 kA/m.

FIG. 16 shows Hₙ change depending on the Co alloy layer thickness. According to FIG. 16, for non-doped and Ag-doped superlattices, Hₙ becomes minimum when the Co layer thickness is 0.3-0.4 nm. For Ag-doped superlattice, H_{c} constantly increases to the maximum as the Co alloy layer thickness increases. By contrast, for Cr-doped superlattice, H_{c} increases only when the Co layer becomes thicker, 0.5-0.7 nm.

As discussed above, doping Ag into the Co alloy layers leads to a decrease in the average saturation magnetization of the superlattice with little decrease in H_{c} and makes it possible to increase the absolute value of Hₙ and enhance the thermal stability of the superlattice. Because metal such as Ag has a face-centered cubic structure, it has affinity with noble metal layer material such as Pd and Pt and its doping into the Co layers does not cause a decrease in Kᵤ and H_{c}. Other additive materials that have the same properties as Ag are Pt, Pd, Au, Rh, Ru, and Cu.

When Cr was doped into the Co layers, with a CoCr metal layer thickness of 0.3 nm, sufficient Kᵤ was not obtained and H_{c} decreased. This is attributable to degraded superlattice crystallinity with the addition of Cr elements. However, it is known that CoCr₁₀ alloy has hcp crystalline structure if it has a thickness to a certain degree. Accordingly, in the thickness range of 0.5-0.7 nm, H_{c} became minimum with a high affinity with the Pd layer. However, thickening the Co alloy layer cancels the effect of reduced saturation magnetization of the Co alloy layer dosed with Cr elements and, thus, the average saturation magnetization of the entire superlattice cannot be reduced.

[Embodiment 5]

While the superlattice examples were mainly discussed in Embodiments 1 to 4. in Embodiment 5, a method of suppressing the temperature-dependent change of coercivity H_{c} by changing the seed layer for the superlattice is described.

In Embodiment 5, a COCu₂₀B₁₀/Pd superlattice (the thickness of Co alloy layers is 0.4 nm) disclosed in Embodiment 4 was used as the recording magnetic layer and its seed layer employed was selected in turn from a set of layers of different composition. Examination thereof and result are described. Table 2 shows the compositions of the seed layers examined and their values of the rate of decrease in H_{c} with temperature rise from 25 to 70 degrees Celsius. Moreover, the magnetic torque loops of the COCu₂₀B₁₀/Pd superlattice on these seed layers, respectively, were measured and the values of the extracted loop components with translational symmetry of 180 degrees L₂ and translational symmetry of 90 degrees L₄ are shown also in Table 2.

In Table 2, a torque loop was defined as toque values per unit volume as a function of angle θ of the magnetization direction of the sample to the direction in which magnetic fields are applied. Normally, a torque loop is measured with a torque magnetometer as a function of angle θ of the perpendicular direction of the sample to the direction in which magnetic fields are applied. Transformation of φ to θ can be made by the following formula (4):

$$sin ( θ - φ ) = \frac{L ( θ )}{{M}_{s} {H}_{ext}} \qquad ( 4 )$$

where L(θ) is magnetic torque, Mₛ is saturation magnetization, and Hₑₓₜ is applied magnetic field. By transforming the torque loop measured with the torque magnetometer into a function of θ, L(θ) as shown in formula (5) is obtained.

L(θ)=L₂ sin 2θ+L₄ sin 4θ (5)

Through Fourier series expansion of the above L(θ), the values of loop components with translational symmetry of 180 degrees and 90 degrees are obtained. Because of single-axis anisotropy of superlattice, the values of the magnetic torque loop components with translational symmetry of odd numbers are virtually zero. In the superlattice of Embodiment 5 having easy axes of magnetization in the perpendicular direction, L₂ is negative.

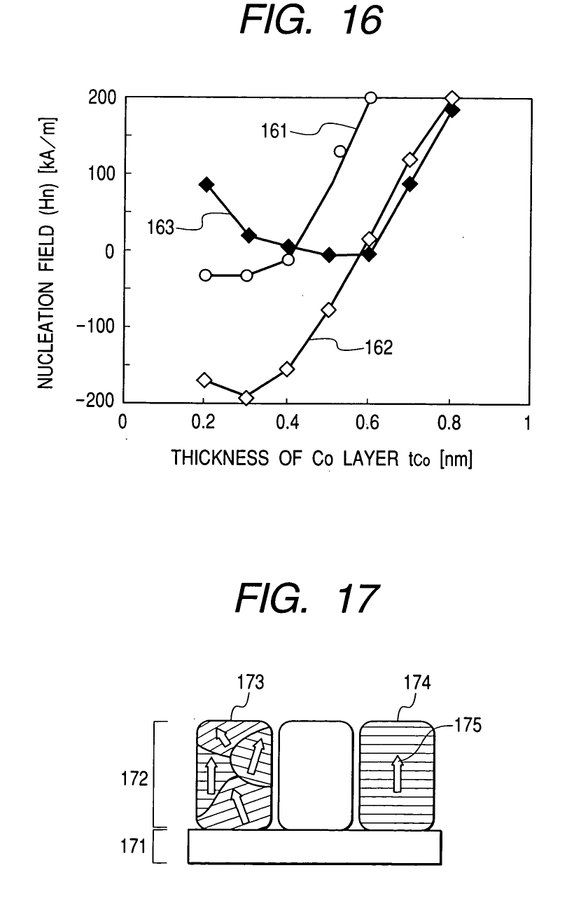

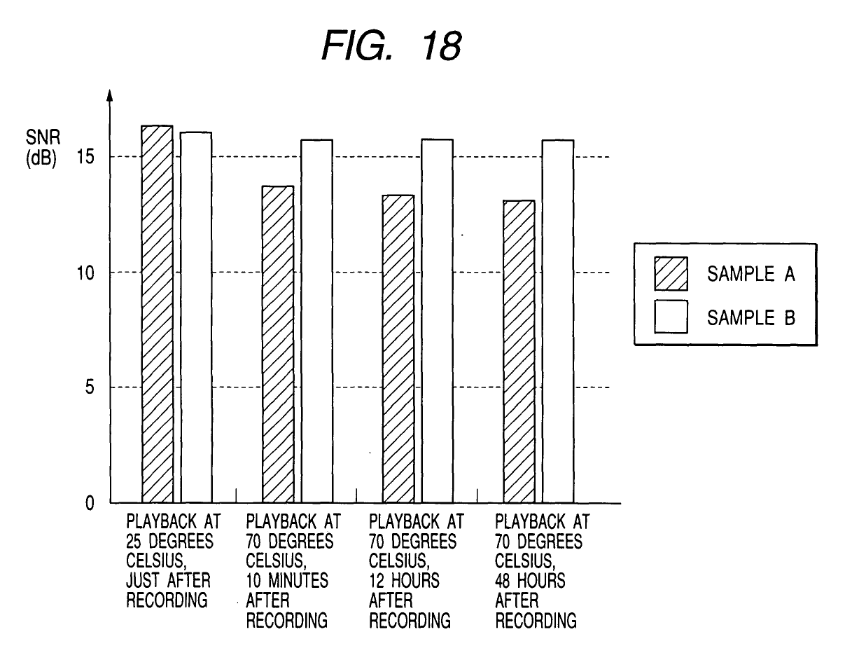

From Table 2, clear relationship between the rate of decrease in coercivity and the magnetic torque loop can be seen. For samples No. 3 and No. 5 in which coercivity decreases much, the polarity (negative) of the values of magnetic torque loop components with translational symmetry of 90 degrees L₄ is in phase with the polarity (negative) of the values of loop components with translational symmetry of 180 degrees L₂. Meanwhile, for samples Nos. 1, 2, and 4 in which the rate of decrease is small, the former polarity (positive) is opposite to the latter polarity of L₂. By fabricating a superlattice that satisfies conditions that Kᵤ2 is positive, that is, the polarity of L₄ is positive, opposite to the polarity of L₂ in the torque loop, a magnetic recording medium in which the temperature-dependent change of coercivity H_{c} is well lessened, which is the goal of the present invention, can be realized. It was found that the polarity of L₄ has relation to dispersion of easy axis directions of magnetization in a magnetic grain. Through observation of superlattice cross sections of samples 3 and 5 with transmission electron microscopy, it was found that one of the magnetic gains surrounded by grain boundaries which comprised sparse atoms consisted of a plurality of different micro-crystals, like a magnetic grain A shown in FIG. 17. In such cases, the micro-crystals have different easy axes of magnetization which are deconcentrated.

Meanwhile, although samples 1, 2, and 4 were formed on different seed layer compositions, through observation with the transmission electron microscopy, it was found that, in their magnetic grains, crystalline orientation was disordered little or almost free of disorder, like a magnetic gain B shown in FIG. 17. An Ru seed layer having a hexagonal close packed lattice and Pd/Ag and other alloy seed layers having a face-centered cubic lattice were used in these samples. Since, intrinsically, it is easy to form a superlattice akin to a face-centered cubic lattice, the use of a seed layer compatible with the superlattice enhances the crystalline orientation in the magnetic grains. However, design for simply arranging crystalline orientations makes it difficult to form grain boundaries and a relatively thick seed layer is required, like the Ru seed layer of sample 1. In the case of sample 4, crystalline orientations were arranged during the first Pd (1 nm) layer formation and basic patterns of gain boundaries formed by combining the metal with MgO in the next step, thereby, a relatively thin seed layer could be realized. In these samples, the easy axes of magnetization were deconcentrated little or almost free of decentration.

The values of magnetic torque loop components with translational symmetry of 90 degrees are believed to reflect whether much or little the easy axes of magnetization were deconcentrated. The polarity of L₄ in phase with the polarity of L₂ indicates that the easy axes of magnetization were deconcentrated much; whereas, the polarity of L₄ opposite to the polarity of L₂ indicates that the easy axes of magnetization were deconcentrated little. In short, diminishing the decentration of the easy axes of magnetization leads to stabilizing the magnetic moment in the noble metal layers and suppressing the temperature-dependent change of coercivity H_{c}.

As explained in Embodiment 5, by selecting a suitable seed layer, the decentration of the easy axes of magnetization can be suppressed. For this purpose, it is desirable to form a layer consisting of Au, Ag, or Ru, or an alloy of thereof directly under the superlattice. These alloy layers may contain Pd or Pt, like sample 2. Alternatively, like sample 4, a composite layer including a layer that exhibits excellent crystalline orientations such as a Pd layer is also preferable.

In another aspect of the invention, a method of fabricating a perpendicular magnetic recording medium including a substrate and a magnetic layer formed on the substrate is provided. In this method, when forming multilayer superlattice films of ferromagnetic metal layers which contain Co and paramagnetic metal layers which consist of Pd and/or Pt on the substrate by sputtering deposition, the product (P₀·D_{TS}) Of sputtering gas pressure P₀ and the distance DTS between the substrate and the targets shall be 20 (Pa·cm) or more.

In the method of fabricating a perpendicular magnetic recording medium, oxygen is used in addition to the sputtering gas during the sputtering deposition process.

As explained hereinbefore, a magnetic recording medium including Co/Pd or Co/Pt multilayer superlattice films in which magnetic grains are separated by grain boundaries which are sparse material and magnetization in the Pd layers of the magnetic grains is stabilized exhibits high recording/readback performances that are less affected by temperature change. Using this magnetic recoding medium, magnetic disk drives that exhibit good performance across a wide range of environmental temperatures can be achieved.

TABLE 1
READ/WRITE SAMPLES

| | FILM STRUCTURE | | | |
|---|---|---|---|---|
| | | SUPERLATTICE | | |
| | UNDER- | RECORDING | CORECIVITY | |
| | LAYER | LAYER | 25° C. | 70° C. |
| SAMPLE A | PdAg (15 nm) | [Co (0.3 nm)/Pd | 555 kA/m | 365 kA/m |
| | | (1.0 nm)] × 15 | | |
| SAMPLE B | PdAg (15 nm) | [Co (0.3 nm)/Pd | 535 kA/m | 485 kA/m |
| | | (0.7 nm)] × 20 | | |

TABLE 2
DEPENDENCE OF Hc DECREASING
RATE ON UNDERLAYER MATERLAYER
MATERIALS AND STRUCTURES

| | UNDERLAYER | | MAGNETIZATION TORQUE LOOP | |
|---|---|---|---|---|
| | (THE ORDER OF | Hc DECREASING | TRANSLATIONAL | TRANSLATIONAL |
| | LAMINATION FROM | RATE | SYMMETRY OF | SYMMETRY OF |
| NUMBER | THE LEFT) | (25° C. → 70° C.) | 90 DEGREE L₂ | 180 DEGREE L₄ |
| 1 | Ru (20 nm) | 8% | −258 kJ/m³ | 13 kJ/m³ |
| 2 | PdAg (15 nm) | 7.5% | −280 kJ/m³ | 16 kJ/m³ |
| 3 | MgO (1 nm)/Pd (1 nm)/ | 16% | −217 kJ/m³ | −24 kJ/m³ |
| | Ru (3 nm) | | | |
| 4 | Pd (1 nm)/MgO (1 nm)/ | 7% | −276 kJ/m³ | 21 kJ/m³ |
| | Pd (1 nm)/Ru (3 nm) | | | |
| 5 | Pd (5 nm)-FILM | 21% | −200 kJ/m³ | −34 kJ/m³ |
| | FORMING IN OXYGEN | | | |

What is claimed is:

1. A perpendicular magnetic recording medium including a substrate and a magnetic layer formed on the substrate, said magnetic layer comprising multilayer superlattice films of ferromagnetic metal layers which contain Co and paramagnetic metal layers which consist of Pd and/or Pt, wherein said ferromagnetic metal layers further contain a paramagnetic element and the thickness of said paramagnetic metal layers is 0.8 nm or less.

2. A perpendicular magnetic recording medium including a substrate and a magnetic layer formed on the substrate, said magnetic layer comprising multilayer superlattice films of ferromagnetic metal layers which contain Co and paramagnetic metal layers which consist of Pd and/or Pt, wherein the rate of decrease in coercivity of said magnetic layer, if exposed to extreme temperature change, shall be less than 0.15 when said rate is evaluated by formula: H_{c} at 25 degrees Celsius−H_{c} at 70 degrees Celsius/H_{c} at 25 degrees Celsius, where H_{c} is the coercivity of said magnetic layer.

3. A perpendicular magnetic recording medium including a substrate and a magnetic layer formed on the substrate, said magnetic layer comprising multilayer superlattice films of ferromagnetic metal layers which contain Co and paramagnetic metal layers which consist of Pd and/or Pt, wherein, when a magnetic torque loop of said perpendicular magnetic recording medium is measured with a torque magnetometer, the polarity of a value of loop components with translational symmetry of 90 degrees is opposite to the polarity of a value of loop components with translational symmetry of 180 degrees.

4. The perpendicular magnetic recording medium according to claim 1, wherein said magnetic layer consists of magnetic grains which are relatively dense and magnetic grain boundaries which are relatively sparse and surround the magnetic grains.

5. The perpendicular magnetic recording medium according to claim 2, wherein said magnetic layer consists of magnetic grains which are relatively dense and magnetic grain boundaries which are relatively sparse and surround the magnetic grains.

6. The perpendicular magnetic recording medium according to claim 3, wherein said magnetic layer consists of magnetic grains which are relatively dense and magnetic grain boundaries which are relatively sparse and surround the magnetic grains.

7. The perpendicular magnetic recording medium according to claim 1, wherein a M-H slope parameter a that corresponds to reversal of magnetization in an M-H loop, falls within a range of 0.5-2.0.

8. The perpendicular magnetic recording medium according to claim 2, wherein a M-H slope parameter a that corresponds to reversal of magnetization in an M-H loop, falls within a range of 0.5-2.0.

9. The perpendicular magnetic recording medium according to claim 3, wherein a M-H slope parameter a that corresponds to reversal of magnetization in an M-H loop, falls within a range of 0.5-2.0.

10. The perpendicular magnetic recording medium according to claim 2, wherein said ferromagnetic metal layers further contain a paramagnetic element and the thickness of said paramagnetic metal layers is 0.8 nm or less.

11. The perpendicular magnetic recording medium according to claim 3, wherein said ferromagnetic metal layers further contain a paramagnetic element and the thickness of said paramagnetic metal layers is 0.8 nm or less.

12. The perpendicular magnetic recording medium according to claim 1, wherein said ferromagnetic metal layers contain at least one of the paramagnetic element selected from the group consisting of Pt, Pd, Au, Ag, Ru, and Cu.

13. The perpendicular magnetic recording medium according to claim 2, wherein said ferromagnetic metal layers contain at least one of the paramagnetic element selected from the group consisting of Pt, Pd, Au, Ag, Ru, and Cu.

14. The perpendicular magnetic recording medium according to claim 3, wherein said ferromagnetic metal layers contain at least one of the paramagnetic element selected from the group consisting of Pt, Pd, Au, Ag, Ru, and Cu.

15. The perpendicular magnetic recording medium according to claim 1, further including a seed layer between said substrate and said magnetic layer, wherein said seed layer is a composite layer comprising an oxide layer and a metal layer which has a face-centered cubic lattice or a hexagonal close packed lattice.

16. The perpendicular magnetic recording medium according to claim 2, further including a seed layer between said substrate and said magnetic layer, wherein said seed layer is a composite layer comprising an oxide layer and a metal layer which has a face-centered cubic lattice or a hexagonal close packed lattice.

17. The perpendicular magnetic recording medium according to claim 3, further including a seed layer between said substrate and said magnetic layer, wherein said seed layer is a composite layer comprising an oxide layer and a metal layer which has a face-centered cubic lattice or a hexagonal close packed lattice.

18. The perpendicular magnetic recording medium according to claim 15, where said seed layer is a metal layer or an alloy layer containing at least one element selected from the group consisting of Au, Ag, and Ru.

19. The perpendicular magnetic recording medium according to claim 16, where said seed layer is a metal layer or an alloy layer containing at least one element selected from the group consisting of Au, Ag, and Ru.

20. The perpendicular magnetic recording medium according to claim 17, where said seed layer is a metal layer or an alloy layer containing at least one element selected from the group consisting of Au, Ag, and Ru.
